(19) United States
(12) Patent Application Publication
(10) Pub. No.: US 2006/0061064 A1
(43) Pub. Date: Mar. 23, 2006

(54) Protective cover for a trailer tongue

(76) Inventor: Kristy Johnson, Oregonia, OH (US)

Correspondence Address: HASSE & NESBITT LLC, 7550 CENTRAL PARK BLVD., MASON, OH, 45040, US

(21) Appl. No.: 10/945,791

(22) Filed: Sep. 21, 2004

(51) Int. Cl. B60D 1/00

(52) U.S. Cl. 280/507

(57) ABSTRACT

A protective cover for a trailer tongue which has an elongated pouch internally sized to receive and encompass the coupler portion and the associated peripheral attachments of a trailer tongue, such as safety chains and electrical wiring, when the trailer is not attached to a towing vehicle. The cover is typically made of flexible material and is impervious to moisture. The cover includes an open end sized to slide over the front end of the trailer tongue, and a closed end sized to fittingly enclose and cover the coupler portion of the tongue. The cover can be held in place at the open end by an attachment means, and the attachment means may include a lock for preventing theft of the protective cover.

The present invention relates in general to trailer tongues. More particularly, the present invention relates to an item and method for covering the tongue of a trailer providing protection for the tongue and associated attachments and accessories, such as the coupler, safety chains, electrical wiring and plug.

### BACKGROUND OF THE INVENTION

Trailers are used to tow a variety of items such as watercraft, vehicles, and equipment. Generally, trailers are connected to the rear of a vehicle by a ball and socket connection. A trailer ball is attached to the rear bumper area of a vehicle. The socket is connected to the trailer and is placed over the ball to secure the trailer to the vehicle. The ball and socket connection is typically used because it allows the trailer to pivot behind the vehicle during a turn. To allow the vehicle to be turned without binding against the trailer, a trailer tongue is positioned at the front of the trailer to provide the space necessary between the trailer and the towing vehicle.

When trailers are detached from the towing vehicle they of course are at rest. Many trailers have a longitudinally-extending trailer tongue with a coupler means located at the very forward end thereof which is adapted to be attached to a ball trailer hitch on the towing vehicle. The coupler means in most cases comprises an inverted cup-like member for receiving a ball trailer hitch. This end of the trailer can pose a serious safety hazard if one accidentally or otherwise bumps into it. Another issue associated with trailer tongues is that they are exposed to the weather, especially when the trailer is detached from the towing vehicle and not kept in a garage. There are also auxiliary apparatus such as safety chains and electrical connecting wires which can be adversely affected by the weather.

Various covers for the trailer couplers and associated auxiliary apparatus associated with trailer tongues have been used. Examples of such trailer tongue covers can be found in U.S. Pat. No. 5,806,873, issued to Glassman and U.S Pat. No. 5,527,056, issued to Hoagland. However, the inventions taught by those patents have disadvantages. Glassman includes a protective cover that only covers the top portion of the tongue and does not adequately protect the chains or electrical wiring from the outside elements. The trailer tongue cover of Hoagland covers the entire trailer tongue assembly, but is bulky and not easily applied to or removed from the trailer.

Therefore, there is a need for a cover that can be easily attached to the trailer tongue when it is detached from the towing vehicle. Such a cover should protect the coupler portion of the trailer tongue as well as the associated peripheral attachment accessories, including safety chains and trailer wiring connector, from the outside elements.

### SUMMARY OF THE INVENTION

The present invention provides a protective cover and method for covering a trailer tongue and associated auxiliary apparatus. The cover typically includes an elongated pouch internally sized to receive and encompass the coupler portion and the associated auxiliary attachments of a trailer tongue, such as safety chains and electrical wiring, when the trailer is not attached to a towing vehicle. The pouch can include a layer of padding and its outer surface is typically impervious to moisture. The pouch can include an open end sized to slide over the front end of the trailer tongue, and a closed end sized to fittingly enclose and cover the coupler portion of the tongue.

The cover can also typically include an attachment means for holding the cover in place on the trailer tongue. One embodiment of the attachment means includes, but is not limited to, a series of grommets or eyelets integrated into the pouch which are secured by cords or bands. The cords can be elastic bands which can fit through the eyelets and be used to tie the open end of the pouch together, or the cords can have hooks at each end, such as is typically seen in a bungee cord strap, which can wrap around the trailer tongue and have the hooks attach to the eyelets to secure the cover. In another embodiment, the cover is held in position by a band of elastic incorporated into the leading edge of the open end of the pouch, allowing for the open end of the cover to be stretched over the trailer tongue, much like a sock is pulled over the toes of a foot. The open end of the cover then returns to the snug position. The attachment means can further include a locking means for preventing the cover from theft. The cover can be made of a flexible material. In one embodiment of the invention, the protective cover is made of a non-permeable, water resistant material that repels water and keeps the covered trailer components from becoming exposed to the outside environmental elements.

The nature and advantages of the present invention will be more fully appreciated from the following drawings and detailed description.

### BRIEF DESCRIPTION OF THE DRAWINGS

The accompanying drawings illustrate embodiments of the invention and, together with a general description of the invention given above, and the detailed description given below, serve to explain the principles of the invention.

FIG. 1 is a bottom view of one embodiment of a protective cover of the invention.

FIG. 2 is a top view of the protective cover of FIG. 1.

FIG. 3 is a top view of one embodiment of a protective cover of the invention.

FIG. 4 is a top view of one embodiment of a protective cover of the invention.

FIG. 5 is a top view of the front portion of a trailer.

FIG. 6 is a side view of the trailer depicted in FIG. 5.

FIG. 7 is a top view of the front portion of a trailer with the protective cover of the present invention mounted thereon.

FIG. 8 is a side view of the front portion of a trailer with the protective cover of the present invention mounted thereon.

### DETAILED DESCRIPTION OF THE INVENTION

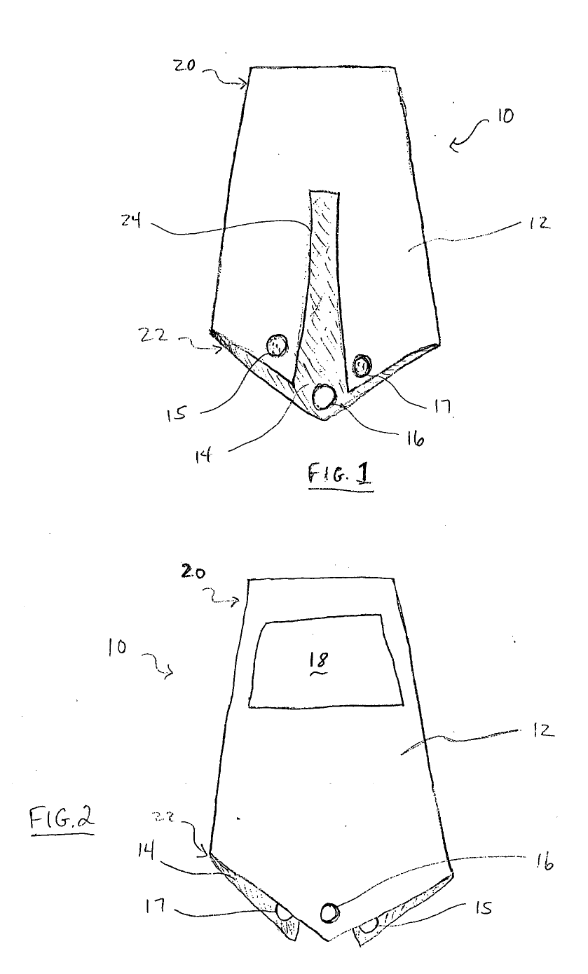

Referring now to one embodiment of the protective cover of the present invention, the protective cover 10 shown in FIG. 1 is an elongated pouch having a closed end 20 and an open end 22, as well as an outer surface 12 and an inner surface 14. The bottom of the cover 10 also has a bottom slit 24 which allows the cover to expand around a trailer tongue. Eyelets or holes 15, 16, and 17 are located at three open comers of the open end 22. The cover 10 is internally sized to receive and encompass the coupler portion and the associated peripheral attachments of a trailer tongue, such as safety chains and electrical wiring, when the trailer is not attached to a towing vehicle.

FIG. 2 illustrates a top view of the cover of FIG. 1. Near the closed end 20 and on the outer surface 12 of the cover, a graphic display 18 can be placed as desired. The graphic display may include, for example, but is not limited to, advertising messages or logos, instructions or warning information, or informational and decorative images. The graphic display 18 may be a separate member affixed by adhesives or sewing, or may be imprinted directly on the outer surface 12. The eyelets 15, 16, and 17 may be simple holes punched through the cover, or they may include, but are not limited to, grommets or hard eyelets lined with protective metal, plastic, or some other material capable of creating a strong hole lining. The eyelets 15, 16, and 17 are operable to receive an attachment means, which can be any device capable of fitting through each of the eyelets to synch or otherwise close the open end 22 after the cover 10 has been slid over the trailer tongue. Other suitable attachment means include locking means for preventing theft of the protective cover, which can include, but is not limited to, a lock similar to a bicycle lock, a padlock, or any other lock that is known in the art.

FIG. 3 illustrates a top view of another embodiment of a protective cover of the invention. The cover 50 includes a closed end 60 and an open end 62, as well as an outer surface 52 and inner surface 54. Eyelets 56 and 57 are located at the open end 62 corners, and are operable to receive attachment means such as described above for the cover of FIGS. 1 and 2.

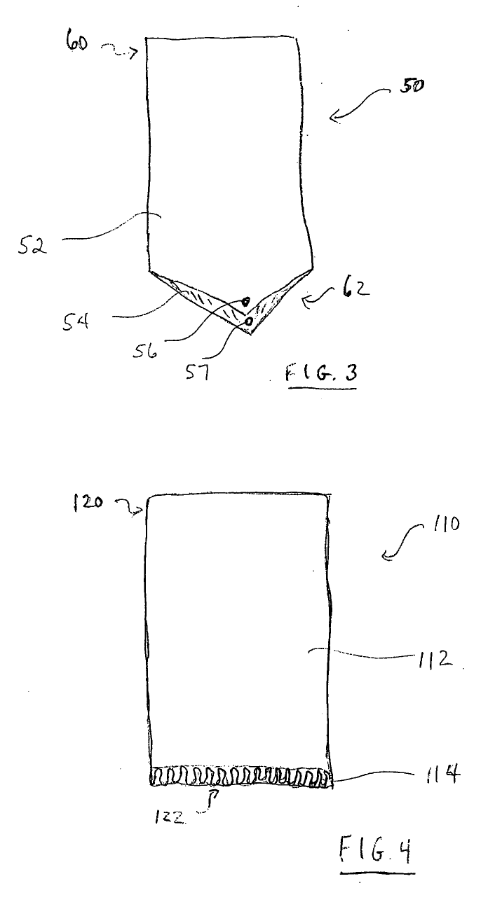

FIG. 4 illustrates yet another embodiment of a protective cover 110, also having a closed end 120 and an open end 122, as well as an outer surface 112 and inner surface (not shown). In this embodiment, the open end 122 includes an elasticized band 114 which provides a snug fit over the trailer tongue. In this embodiment, the portion of the trailer tongue covered may be better protected from the outside elements, due to the tight-fitting manner of the elasticized open end.

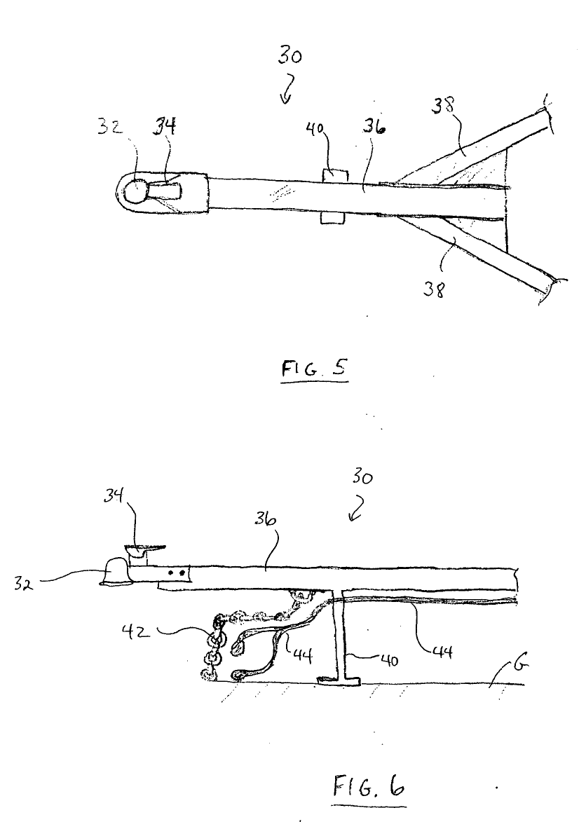

FIGS. 5 and 6 show a coupler portion 30 of a trailer tongue of a typical trailer, which includes an inverted cup 32 sized to receive a ball of a hitch attached to a towing vehicle. A typical lever-type member 34 is present to pivot and lock the inverted cup 32 to the towing ball, as is known to those of skill in the art. A longitudinally extending member 36 with side braces 38 is supported by a support member 40 for resting the trailer tongue on the ground G when the trailer is not in use. Other features of the coupler portion of the trailer tongue include associated peripheral attachments, such as a safety chain 42 and the trailer electrical wiring 44.

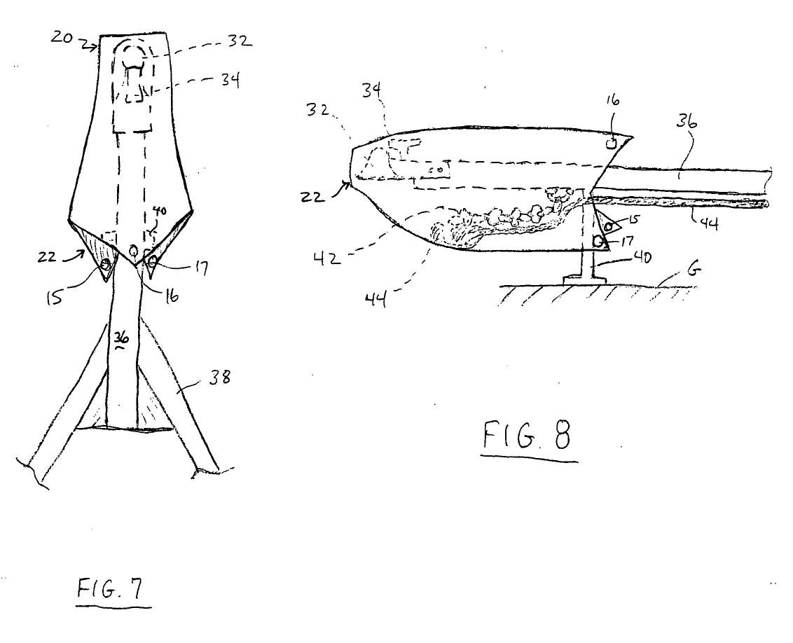

Referring now to FIG. 7, a top view of one embodiment of the protective cover is shown installed over the coupler portion of the trailer tongue. The cover is sufficiently dimensioned or internally sized so as to receive both the forward coupler portion of the trailer tongue, including the inverted cup 32, the lever-type member 34, and the longitudinally extending member 36 up to the area of the support member 40. The closed end 20 of the cover fittingly engages the coupler portion including the inverted cup 32 and lever-type member. The eyelets 15, 16, and 17 are located at the open end 22 of the cover near the support member 40 of the trailer tongue.

As can be clearly seen in FIG. 8, the protective cover is also sufficiently dimensioned and internally sized so as to receive the associated peripheral attachments, notably the safety chain 42 and the trailer electrical wiring 44. Attachment means (not shown), which can be items such as simple drawstrings, bungee cords with hooks, or complicated locking devices, can now fit through the eyelets 15, 16, and 17 and securely fasten the cover to enclose and protect the trailer tongue. In another embodiment, shown in FIG. 4, the leading edge of the open end of the cover includes an elasticized band which acts as an attachment means as well, neatly securing the cover over the end of the trailer tongue.

The protective cover is typically used when the trailer is in a stationary position and not attached to a towing vehicle. The cover is typically made of flexible material and is impervious to moisture. The open end is sized to slide over the forward section of the trailer tongue, and the closed end is sized appropriately to fittingly enclose and cover the coupler portion of the tongue and associated auxiliary apparatus.

The protective cover of the present invention provides one or more of the following advantages. It protects the trailer tongue as well as the associated safety chain and electrical wiring from the elements, when the trailer is not in use. It may also be folded into a small volume for easy storage when the cover is not in use, perhaps fitting into a small compartment or glove box within the trailer or the towing vehicle. Furthermore, it may be easily attached and removed from the trailer tongue. It may be made of a minimal amount of flexible, lightweight materials. It is also economical to manufacture, and may be provided in various styles, materials, and colors to meet the needs of consumers.

While the present invention has been illustrated by the description of embodiments thereof, and while the embodiments have been described in considerable detail, it is not intended to restrict or in any way limit the scope of the appended claims to such detail. Additional advantages and modifications will be readily apparent to those skilled in the art. The invention in its broader aspects is therefore not limited to the specific details, representative apparatus and method, and illustrated examples shown and described. Accordingly, departures may be made from such details without departing from the scope or spirit of the invention.

What is claimed is:

1. A protective cover for a coupler portion and associated auxiliary attachments of a trailer tongue when the trailer is not attached to a towing vehicle, comprising:
an elongated pouch including an open end and a closed end; and
an attachment means operable to hold the cover onto the trailer tongue,
wherein the pouch is internally sized to receive and encompass the coupler portion and associated auxiliary attachments of the trailer tongue, the open end is sized to slide over the front end of the coupler portion, and the closed end is sized to fittingly enclose and cover the coupler portion.

2. The cover of claim 1, wherein at least the outer surface of the pouch is impervious to moisture.

3. The cover of claim 1, wherein the pouch includes a layer of padding.

4. The cover of claim 1, wherein the attachment means includes a series of eyelets incorporated into the open end of the pouch, and an elastic cord having a hook on each end, each hook operable to attach to an eyelet.

5. The cover of claim 1, wherein the attachment means includes an elastic band incorporated into the leading edge of the open end.

6. The cover of claim 1, wherein the attachment means includes a locking means for the cover.

7. The cover of claim 1, wherein the pouch presents a surface for displaying graphical indicia.

8. The cover of claim 1, wherein the pouch is formed from a flexible material.

9. A method of protecting a coupler portion and associated auxiliary attachments of a trailer tongue when the trailer is not attached to a towing vehicle, the method comprising:
providing a protective cover for the coupler portion and associated auxiliary attachments, the cover comprising an elongated pouch including an open end and a closed end, and an attachment means operable to hold the cover onto the trailer tongue, wherein the pouch is internally sized to receive and encompass the coupler portion and associated auxiliary attachments of the trailer tongue, the open end is sized to slide over the front end of the coupler portion, and the closed end is sized to fittingly enclose and cover the coupler portion.

10. The method of claim 9, wherein at least the outer surface of the pouch is impervious to moisture.

11. The method of claim 9, wherein the pouch includes a layer of padding.

12. A protective cover for a coupler portion and associated auxiliary attachments of a trailer tongue when the trailer is not attached to a towing vehicle, comprising:
an elongated pouch including an open end, a closed end, an inner layer, and an outer layer, the outer layer having a surface for displaying graphical indicia, at least one of the layers being impervious to moisture, at least one of the layers having a padding, the pouch being made of a flexible material; and
an attachment means operable to hold the cover onto the trailer tongue,
wherein the pouch is internally sized to receive and encompass the coupler portion and associated auxiliary attachments of the trailer tongue, the open being sized to slide over the front end of the coupler portion, the closed end being sized to fittingly enclose and cover the coupler portion.

13. The cover of claim 12, wherein the attachment means includes a series of eyelets incorporated into the open end of the pouch and a cord operable to fit through the eyelets to tie the open end around the tongue of the trailer.

14. The cover of claim 13, wherein the cord is elastic and includes a hook at each of its ends, each hook operable to fit into and attach to an eyelet.

15. The cover of claim 12, wherein the attachment means includes an elastic band incorporated into the leading edge of the open end, wherein the band is operable to fittingly surround the tongue of the trailer.
